(19) United States
(12) Patent Application Publication
(10) Pub. No.: US 2002/0103886 A1
(43) Pub. Date: Aug. 1, 2002

(54) Non-local aggregation of system management data

(75) Inventor: Freeman Leigh Rawson III, Austin, TX (US)

Correspondence Address: Andrew J. Dillon, FELSMAN, BRADLEY, VADEN, GUNTER & DILLON, LLP, Lakewood on the Park, Suite 350, 7600B North Capital of Texas Highway, Austin, TX, 78731, US

(73) Assignee: International Business Machines Corporation

(21) Appl. No.: 09/727,825

(22) Filed: Dec. 4, 2000

(51) Int. Cl. G06F 15/173

(52) U.S. Cl. 709/223; 709/224

(57) ABSTRACT

Rather than aggregating management information locally on the server system which is described by the information, cluster system management information is received separately from lightweight probes at each of four levels on every server system within a cluster: application server, operating system, network, and hardware. The information received is aggregated first on each of the levels identified, with the aggregate levels of information being combined to create a single management image for the cluster. System management commands are generated and distributed in reverse fashion, divided at each of the four levels and then subdivided by individual system. An XML data stream containing the system image is created and transmitted to adapters for existing management systems, allowing such existing management systems to be employed in controlling cluster operation.

### BACKGROUND OF THE INVENTION

1. Technical Field

The present invention relates generally to managing computer server clusters and in particular to gathering management information and distributing management commands within computer server clusters. Still more particularly, the present invention relates to aggregating management information regarding individual servers at a designated management system rather than locally on each system to which the information relates.

2. Description of the Related Art

The trend toward concentrating data processing system resources, especially server resources, in rack-mounted, centralized environments leads to a situation where a very large number of traditionally individual data processing systems are being utilized to provide network-based services. For example, most large-scale Internet sites consist of some very large number of data processing systems, often rack-mounted, all of which offer the content and function of the site, or which cooperate to produce that function.

Any time large numbers of servers are congregated together to perform a critical function or provide critical services, such as running web-based applications, management of such systems—configuring, monitoring, diagnosing, correcting, and commanding—becomes an issue, and often a labor-intensive problem which is expensive to solve. Owners, customers, and users need to know when individual systems have failed or are about to fail; changes inevitably occur in the configuration and programming required; and resources such as disk space and network bandwidth must be monitored and allocated. To perform these functions well, the management system must gather information about the hardware, the network, the operating system, and the application(s) for each data processing system and then collate such information into a complete picture of that system's status. Once the information is collected and organized for each server, the results must be combined for an overall picture of the cluster.

Traditional solutions to management of server clusters or farms have taken a whole-system approach in which each individual system is managed as a single, stand-alone unit which is networked with the other systems. These management approaches focus on self-contained local management of a whole system, although perhaps from a remote terminal or through a web browsers, accompanied by management of large numbers of such self-contained systems using large-scale management software. The aggregation of information about a single system is thus typically performed on that system itself, and all of the key management functions execute on each system subject to a high level management structure which controls those management functions and also performs network management. However, this approach imposes a tax or cost on each system, consuming processing time and memory and possibly degrading application performance.

In addition, management of very large numbers of individual items by an individual person is very difficult. The complexity becomes overwhelming, leading to errors, stress and very high costs. Aggregation of management information and control for all servers within a cluster into a single point, presenting the appearance of a single system, would dramatically increase system manageability by an individual and provide a consequent reduction in cost.

Another related problem is the use of complex and/or unique formats for transmission and exchange of system management information. Such formats inhibit exchange of data between different management systems (e.g., Tivoli's Enterprise Manager and Computer Associates' UniCenter), and the creation of standard interfaces to such existing, very large-scale management systems.

Generally, much of the dissatisfaction with existing management solutions lies in the fact that administration and management of a cluster system is very close to administering and managing all of the nodes as individual systems plus administering and managing the interconnection between the systems.

It would be desirable, therefore, to remove most of the management processing to a separate, centralized system to minimize the impact of that management on the “real” work being performed by the server cluster. It would also be desirable to combine information from the servers into a single-system execution image for the purposes of management and administration.

### SUMMARY OF THE INVENTION

It is therefore one object of the present invention to provide improved management of computer server clusters.

It is another object of the present invention to improvement in gathering management information and distributing management commands within computer server clusters.

It is yet another object of the present invention to aggregate management information regarding individual servers at a designated management system rather than locally on each system to which the information relates.

The foregoing objects are achieved as is now described. Rather than aggregating management information locally on the server system which is described by the information, cluster system management information is received separately from lightweight probes at each of four levels on every server system within a cluster: application server, operating system, network, and hardware. The information received is aggregated first on each of the levels identified, with the aggregate levels of information being combined to create a single management image for the cluster. System management commands are generated and distributed in reverse fashion, divided at each of the four levels and then subdivided by individual system. An XML data stream containing the system image is created and transmitted to adapters for existing management systems, allowing such existing management systems to be employed in controlling cluster operation.

The above as well as additional objectives, features, and advantages of the present invention will become apparent in the following detailed description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of a data processing system network in accordance with a preferred embodiment of the present invention; and

FIG. 2 is a high level flow chart for a process of managing a cluster of servers in accordance with a preferred embodiment of the present invention.

### DETAILED DESCRIPTION

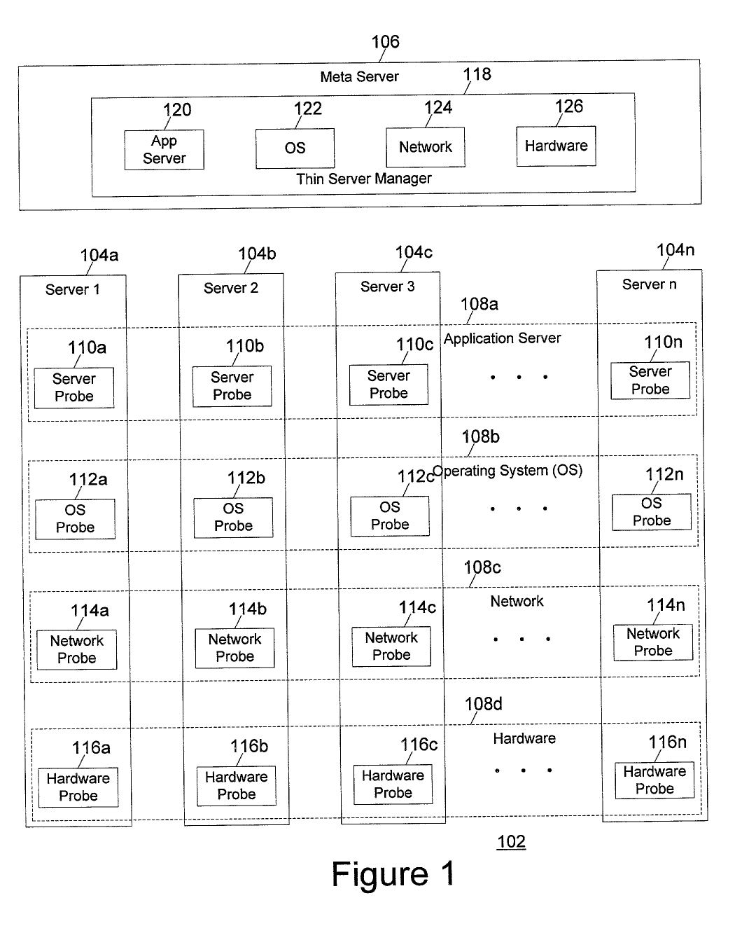

With reference now to the figures, and in particular with reference to FIG. 1, a block diagram of a data processing system network in accordance with a preferred embodiment of the present invention is depicted. In the present invention, a server farm or cluster 102 includes an integer number n of server systems 104a-104n which collaborate to perform functions and provide services such as running web-based applications. Server systems 104a-104n are coupled by networking hardware and software implementing a distributed computing environment in accordance with the known art. Cluster 102 also includes a meta server 106 which provides non-local aggregation of system management information as described in further detail below.

The management information and management control points for cluster 102 may be divided into two dimensions. The first dimension (vertical in FIG. 1) gives a complete picture of an individual server system in the cluster 102. There are four layers within this vertical dimension (taken from the top down): application (or application server) layer 108a, operating system layer 108b, network layer 108c, and hardware layer 108d. In the second (horizontal) dimension, each of these layers 108a-108d may be aggregated across each server in the farm or cluster 102.

Unlike standard management systems, the present invention employs management from the top down, working downward from the service level by taking advantage of the application-server based model of application programming and by probing the application server. Additionally, management information is sent as disconnected pieces to a management or “meta” server 106 rather than aggregating management information on each local system 104a-104n which the management information describes. Furthermore, existing management systems generally do not enable management of the cluster per se; instead, such systems merely enable management of each individual system within the cluster.

To minimize the impact of management on individual systems 104a-104n within cluster 102, relatively lightweight probes 110a-110n, 112a-112n, 114a-14n and 116a-116n are employed at each level 108a-108d of the implementation. Probes 110a 110n, 112a 112n, 114a 114n and 116a 116n are “lightweight” in that the burden on the system being probed is the minimal required use of resources necessary to obtain information regarding system performance; aggregating the information obtained and command and control are performed outside the system contain the probes. Probes 110a-110n, 112a-112n, 114a-114n and 116a-116n are utilized by both the information-gathering and command and control mechanisms. Although uniform across systems of the same type at each level, the specific implementation details of probes 110a-110n, 112a-112n, 114a-114n and 116a-116n will vary greatly from level to level and from one system type to another.

Probes 110a-110n, 112a-112n, 114a-14n and 116a-116n gather the same types of management information as is collected in existing cluster management solutions, and respond to similar types of commands and controls. However, each probe 110a-110n, 112a-112n, 114a-14n and 116a-116n only gathers information regarding the particular system on which the respective probe is located, and only for the specific level 108a-108d on which the respective probe was designed to operate. The task of aggregating collected information is performed on the meta server 106.

As a result of the four levels 108a-108d into which the n servers 104a-104n are logically divided, each system 104a-104n has four discrete levels of information and the cluster 102 of n systems 104a-104n encompass 4n individual loci of information and control. Rather than aggregating the information from each of the layers 108a-108d in the vertical dimension on a system 104a-104n, probes 110a-110n, 112a-112n, 114a-14n and 116a-116n are located at each level and transmit gathered information to meta server 106 separately. A thin server manager program 118 executing on meta server 106 collects all of the information from probes 110a-110n, 112a-112n, 114a-14n and 116a-116n and creates a single-system image for the entire cluster 102. Thin server manager 118 collects the information by combining the information at each level 108a-108d across the entire cluster 102, then stacking the four resulting combined layers of information together. Accordingly, thin server manager 118 may have separate modules 120, 122, 124 and 126 corresponding to each level 108a-108d.

Exemplary pseudo-code representing the logic for performing the information gathering functions is:

for each layer in (hardware, network, operating system,

application server) do
for (i = 0; i < n; i++) do

insert information from system n into global

layer structure

enddo
add completed layer to global system image

enddo

While the above pseudo-code relates to information collection, or the monitoring side of cluster management, the command and control side, which relays commands to the probes at each layer based on management policy, automation, and human decision-making, has the same overall structure, except that communication is initiated by the thin server manager 118 rather than by probes 110a-110n, 112a-112n, 114a-14n and 116a-116n. Probes 110a-110n, 112a-112n, 114a-14n and 116a-116n at each layer on each system receive commands which the respective probes execute against the corresponding level 108a-108d within the system 104a-104n on which that probe is located. Overall command decisions are divided into commands directed at each layer 108a-108d, then further subdivided among the individual systems 104a-104n within the cluster 102.

The approach to information gathering and command and control distribution employed by the present invention has two primary advantages over conventional aggregation of information locally on each system. First, the resources consumed by the management software on the individual systems being managed is minimized at the cost of using network bandwidth (which is assumed to be available in generous supply) and the use of a special meta server. Second, rather than creating a larger management image out of the images of many individual systems, the management information is aggregated across all systems at each layer, then combined to form a single image which covers all of the individual systems being managed. Rather than having n instances of an application server, a single instance is received with the resources of n systems to use in processing the work.

While the approach of the present invention provides management at the cluster or server farm level, customers having content or applications hosted by the server farm may desire to manage their applications utilizing their standard management system. To make communication with other management infrastructures (such as Tivoli GEM, CA Unicenter, VA Linux's Cluster City) feasible, the thin server manager 118 generates an extensible markup language (XML) stream which is employed as a messaging format. Each different management system may be equipped with an adapter consuming the XML stream and generating the specific input required by that management system. Adapters will, therefore, be specific to particular management systems.

To reduce the overhead required, the existing management system's agent code, the adapter, and the thin server manager 118 all execute on the meta server 106, making all of the data transfers local, although the standard management system must still communicate to servers located on other systems (outside cluster 102). In cases where the cluster 102 is partitioned among a number of different organizations having content and applications hosted on cluster 102, multiple XML streams may be employed, and multiple adapters and multiple system management agents, one per partition.

The use of XML provides a number of advantages. From the perspective of the developers of the thin server manager 118, the need to create a special graphical user interface is avoided since the XML stream can be interpreted and rendered by the current generation of browsers. In addition, customers of the server farm may employ their own management facilities, which are often well-established within their organizations. The use of XML also provides a neutral format for the exchange of management information without favoring any particular vendor.

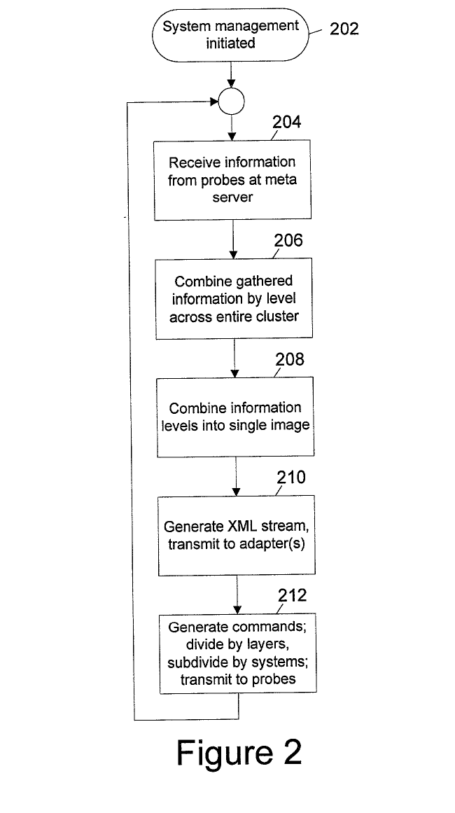

Referring to FIG. 2, a high level flow chart for a process of managing a cluster of servers in accordance with a preferred embodiment of the present invention is illustrated. The process begins at step 202, which depicts management of the cluster being initiated. The process first passes to step 204, which illustrates receiving information from level-specific probes at each individual server within the cluster, then to step 206, which depicts combining the received information by level across the entire cluster, and then to step 208, which illustrates combining the levels of aggregated information into a single management image of the cluster. This single management image differs from a single system image distributed computing operating systems in that individual systems within the cluster still run their own operating systems and execute separate (although possibly related) streams of work.

The process next passes to step 210, which depicts generating an XML stream corresponding to the cluster image and transmitting the XML stream to adapters for existing system management software. The process then passes to step 212, which illustrates generating the commands needed to control operation of the cluster, in response to receiving commands from the management system, then dividing the commands by level and subdividing the command levels by system, and finally transmitting the individual commands to the appropriate probes. The process then returns to step 204 to gather additional management information and repeat the process.

The present invention utilizes a distributed approach to cluster management, but changes the balance between the probes within servers being managed and the central meta server facility to reduce the size and impact of the probes at the expense of greater bandwidth utilization and increased dependence on the meta server. Information is transferred from the various levels being managed separately rather than being aggregated within the system being managed and then transferred. Aggregation is performed at the central meta server and proceeds level by level and then between levels to create a better single-system image for the cluster. Standard system management agents may be employed and permitted to manage the cluster or a partition of the cluster. A neutral format for exporting management information to standard system management agents is employed using a per-agent adapter and allowing the exchange of information and control through the neutral format. The present invention thus offers a single management system image which enables existing management solutions to manage the cluster as a unit, while also allowing clusters to be built out of server appliances which are not capable of supporting agents employed by traditional management systems.

It is important to note that while the present invention has been described in the context of a fully functional data processing system and/or network, those skilled in the art will appreciate that the mechanism of the present invention is capable of being distributed in the form of a machine usable medium of instructions in a variety of forms, and that the present invention applies equally regardless of the particular type of signal bearing medium used to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and CD-ROMs, and transmission type mediums such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of gathering management information from servers within a cluster, comprising:
receiving management information from probes at each of a plurality of levels within every server within the cluster;
aggregating the received management information at each of the plurality of levels across all servers within the cluster; and
combining the aggregate levels of management information to form a single management image of the cluster.

2. The method of claim 1, wherein the step of receiving management information from probes at each of a plurality of levels within every server within the cluster further comprises:
receiving information from lightweight probes within every server at each of the plurality of levels including an application server level, an operating system level, a network level, and a hardware level.

3. The method of claim 1, wherein the step of aggregating the received management information at each of the plurality of levels across all servers within the cluster further comprises:
aggregating the received management information at each of the plurality of levels including an application server level, an operating system level, a network level, and a hardware level.

4. The method of claim 3, wherein the step of aggregating the received management information at each of the plurality of levels including an application server level, an operating system level, a network level, and a hardware level further comprises:
aggregating the received management information at a designated management server rather than on each server within the cluster.

5. The method of claim 4, wherein the step of combining the aggregate levels of management information to form a single management image of the cluster further comprises:
combining the aggregate levels of management information at the designated management server.

6. The method of claim 1, further comprising:
generating an extensible markup language data stream containing the single image of the cluster; and
transmitting the data stream to an adapter for each system management application executing on a designated management server within the cluster.

7. The method of claim 1, further comprising:
generating commands based on the single image of the cluster;
dividing the commands based upon a plurality of levels including an application server level, an operating system level, a network level, and a hardware level;
subdividing the divided commands according to individual servers within the cluster; and
transmitting each subdivided commands to respective probes at a corresponding level within a server within the cluster.

8. A system for gathering management information from servers within a cluster, comprising:
means for receiving management information from probes at each of a plurality of levels within every server within the cluster;
means for aggregating the received management information at each of the plurality of levels across all servers within the cluster; and
means for combining the aggregate levels of management information to form a single management image of the cluster.

9. The system of claim 8, wherein the means for receiving management information from probes at each of a plurality of levels within every server further comprises:
means for receiving information from lightweight probes within every server at each of the plurality of levels including an application server level, an operating system level, a network level, and a hardware level.

10. The system of claim 8, wherein the means for aggregating the received management information at each of the plurality of levels across all servers within the cluster further comprises:
means for aggregating the received management information at each of the plurality of levels including an application server level, an operating system level, a network level, and a hardware level.

11. The system of claim 10, wherein the means for aggregating the received management information at each of the plurality of levels including an application server level, an operating system level, a network level, and a hardware level further comprises:
means for aggregating the received management information at a designated management server rather than on each server within the cluster.

12. The system of claim 11, wherein the means for combining the aggregate levels of management information to form a single image of the cluster further comprises:
combining the aggregate levels of management information at the designated management server.

13. The system of claim 8, further comprising:
means for generating an extensible markup language data stream containing the single image of the cluster; and
means for transmitting the data stream to an adapter for each system management application executing on a designated management server within the cluster.

14. The system of claim 8, further comprising:
means for generating commands based on the single image of the cluster;
means for dividing the commands based upon a plurality of levels including an application server level, an operating system level, a network level, and a hardware level;
means for subdividing the divided commands according to individual servers within the cluster; and
means for transmitting each subdivided commands to respective probes at a corresponding level within a server within the cluster.

15. A computer program product within a computer usable medium for gathering management information from servers within a cluster, comprising:
instructions for receiving management information from probes at each of a plurality of levels within every server within the cluster;
instructions for aggregating the received management information at each of the plurality of levels across all servers within the cluster; and
instructions for combining the aggregate levels of management information to form a single management image of the cluster.

16. The computer program product of claim 15, wherein the instructions for receiving management information from probes at each of a plurality of levels within every server within the cluster further comprises:
instructions for receiving information from lightweight probes within every server at each of the plurality of levels including an application server level, an operating system level, a network level, and a hardware level.

17. The computer program product of claim 15, wherein the instructions for aggregating the received management information at each of the plurality of levels across all servers within the cluster further comprises:
instructions for aggregating the received management information at each of the plurality of levels including an application server level, an operating system level, a network level, and a hardware level.

18. The computer program product of claim 17, wherein the instructions for aggregating the received management information at each of the plurality of levels including an application server level, an operating system level, a network level, and a hardware level further comprises:
instructions for aggregating the received management information at a designated management server rather than on each server within the cluster.

19. The computer program product of claim 18, wherein the instructions for combining the aggregate levels of management information to form a single image of the cluster further comprises:
combining the aggregate levels of management information at the designated management server.

20. The computer program product of claim 19, further comprising:
instructions for generating an extensible markup language data stream containing the single image of the cluster; and
instructions for transmitting the data stream to an adapter for each system management application executing on a designated management server within the cluster.

21. The computer program product of claim 19, further comprising:
instructions for generating commands based on the single image of the cluster;
instructions for dividing the commands based upon a plurality of levels including an application server level, an operating system level, a network level, and a hardware level;
instructions for subdividing the divided commands according to individual servers within the cluster; and
instructions for transmitting each subdivided commands to respective probes at a corresponding level within a server within the cluster.
